(19) United States
(12) Patent Application Publication
(10) Pub. No.: US 2026/0201848 A1
(43) Pub. Date: Jul. 16, 2026

(54) REGENERATOR CONSTRUCTION AND STRUCTURAL DESIGN FOR ENHANCED PERFORMANCE IN VUILLEUMIER HEAT PUMPS

(71) Applicant: Thermolift, Inc., Novi, MI (US)

(72) Inventors: Peng Shi, Livonia, MI (US); Haoxiang Yang, Farmington Hills, MI (US); Haocheng Yang, Farmington Hills, MI (US)

(21) Appl. No.: 19/448,910

(22) Filed: Jan. 14, 2026

Related U.S. Application Data
(60) Provisional application No. 63/745,051, filed on Jan. 14, 2025.

(51) Int. Cl. F02G 1/057; F02G 1/044

(52) U.S. Cl. CPC F02G 1/057; F02G 1/0445; F02G 2250/18; F02G 2257/00

(57) ABSTRACT

Described are embodiments of a regenerator device for use in heat engine and heat pump systems to perform thermodynamic cycles. An example regenerator device includes an inner liner, an outer liner, and a bulk matrix material positioned between the inner liner and the outer liner. The regenerator device further includes an insulation layer and a porous layer positioned between the inner liner and the bulk matrix material. Some embodiments further include a second porous layer positioned between the outer liner and the bulk matrix material. Also described are embodiments of secondary heat exchangers for use in conjunction with the regenerator device in a heat pump system to perform thermodynamic cycles. Example secondary heat exchangers each include an outer shell having a geometry at least partly defining a mixing chamber at an end of the regenerator device.

### CROSS-REFERENCE TO RELATED APPLICATIONS

This application claims the benefit of and priority to U.S. Provisional Patent Application No. 63/745,051 filed Jan. 14, 2025, titled “REGENERATOR CONSTRUCTION AND STRUCTURAL DESIGN FOR ENHANCED PERFORMANCE IN VUILLEUMIER HEAT PUMPS,” the entire contents of which is hereby incorporated herein by reference.

### BACKGROUND

The term “thermal energy” refers to a number of physical concepts. In thermodynamics, heat is energy transferred to or from a thermodynamic system by mechanisms other than thermodynamic work or transfer of matter. Such heat energy transfer occurs during a number of different known thermodynamic cycles. Example thermodynamic cycles in which such heat energy transfer occurs include the Vuilleumier cycle in a Vuilleumier heat pump and the Stirling cycle in a Stirling engine.

Regenerators are a part of the common functionality in Stirling and Vuilleumier cycles. The Vuilleumier heat pump, a highly efficient thermodynamic system, relies heavily on the performance of its regenerators. These regenerators play a key role in the thermodynamic cycle by acting as “thermal capacitors” to store and deliver heat to the working fluid traveling through them. For instance, chambers of a Vuilleumier heat pump are able to maintain a temperature differential to drive a Vuilleumier cycle and a regenerator stores excess or unused thermal energy as the working fluid moves back and forth between the chambers. In playing such a critical role in the cycle, the design and fabrication of the regenerator must be very intentional to ensure optimal performance. Current regenerator designs face significant challenges that impede their efficiency and effectiveness.

### SUMMARY

The present disclosure is directed to multiple embodiments of a regenerator that can be used in various heat engine systems and heat pump systems to perform different thermodynamic cycles. Some embodiments include a hot regenerator, while others include a cold regenerator. The regenerator embodiments can each store and deliver thermal energy to a working fluid and maintain a temperature difference between hot and cold chambers. The regenerators can each be embodied and implemented as a radially insulated regenerator having at least one of an insulation layer or a porous layer positioned between an inner liner and a bulk matrix material of the regenerator. The porous layer can have a lower porosity compared to that of the bulk matrix material to reduce flow and heat transfer near the regenerator's inner liner.

Some embodiments include a second porous layer positioned between an outer liner of the regenerator and an outer surface of the regenerator's matrix. The second porous layer can also have a lower porosity compared to that of the bulk matrix material to reduce flow and heat transfer near the regenerator's outer liner. Other embodiments include at least one diffuser positioned at one or more ends of the regenerator between the inner liner and the outer liner of the regenerator. The diffusers can each be embodied as a perforated plate that creates a relatively even fluid flow for a working fluid moving into, through, and out of the regenerator.

Other embodiments include secondary heat exchangers for use in conjunction with the regenerator to perform thermodynamic cycles in a heat pump or heat engine system. Example secondary heat exchangers each include an outer shell having a geometry at least partly defining a mixing chamber (or “diffusion chamber”) at a respective end of the regenerator. The mixing chambers create a relatively even fluid flow for a working fluid moving into, through, and out of the regenerator. Even distribution of a working fluid created by at least one of the diffusers or the mixing chambers ensures a more uniform and improved heat transfer through the regenerator, as there are limited or even no areas in the working fluid that have more or less flow than other areas.

Aspects and advantages of embodiments of the present disclosure will be set forth in part in the following description or can be learned from the description or through practice of the embodiments. Other aspects and advantages of embodiments of the present disclosure will become better understood with reference to the appended claims and the accompanying drawings, all of which are incorporated in and constitute a part of this specification. The drawings illustrate example embodiments of the present disclosure and, together with the description, serve to explain the related concepts of the present disclosure.

According to one example embodiment, a regenerator device includes an inner liner, an outer liner, and a bulk matrix material positioned between the inner liner and the outer liner. The regenerator device further includes an insulation layer and a porous layer positioned between the inner liner and the bulk matrix material.

According to another example embodiment, a regenerator device includes an inner liner, an outer liner, and a bulk matrix material positioned between the inner liner and the outer liner. The regenerator device further includes an inner porous layer positioned between the inner liner and the bulk matrix material. The regenerator device further includes an outer porous layer positioned between the outer liner and the bulk matrix material.

According to another example embodiment, a heat pump system includes a first secondary heat exchanger, a second secondary heat exchanger, and a regenerator device coupled to the first secondary heat exchanger and the second secondary heat exchanger. The regenerator device includes an inner liner, an outer liner, and a bulk matrix material positioned between the inner liner and the outer liner. The regenerator device further includes an insulation layer and a porous layer positioned between the inner liner and the bulk matrix material.

### BRIEF DESCRIPTION OF THE DRAWINGS

Many aspects of the present disclosure can be better understood with reference to the following figures. The components in the figures are not necessarily to scale, with emphasis instead being placed upon clearly illustrating the concepts of the disclosure. Moreover, repeated use of reference characters or numerals in the figures is intended to represent the same or analogous features, elements, or operations across different figures. Repeated description of such repeated reference characters or numerals is omitted for brevity.

FIG. 1A illustrates a perspective view of an example regenerator device in accordance with various aspects and embodiments of the present disclosure.

FIG. 1B illustrates a cross-sectional side view of the example regenerator device shown in FIG. 1A in accordance with various aspects and embodiments of the present disclosure.

FIG. 2A illustrates a perspective view of an example secondary heat exchanger device in accordance with various aspects and embodiments of the present disclosure.

FIG. 2B illustrates a cross-sectional side view of the example secondary heat exchanger device shown in FIG. 2A in accordance with various aspects and embodiments of the present disclosure.

FIG. 3A illustrates a perspective view of another example secondary heat exchanger device in accordance with various aspects and embodiments of the present disclosure.

FIG. 3B illustrates a cross-sectional side view of the example secondary heat exchanger device shown in FIG. 3A in accordance with various aspects and embodiments of the present disclosure.

FIG. 4 illustrates a cross-sectional side view of an example heat pump system in accordance with various aspects and embodiments of the present disclosure.

### DETAILED DESCRIPTION

Regenerators are a part of the common functionality in Stirling and Vuilleumier thermodynamic cycles. Regenerators generally include a bulk matrix material with a large surface area to volume ratio. The bulk matrix material is typically a porous material, stacked wire mesh, or a microchannel design. The porosity of the bulk matrix material is specifically designed to optimize a low pressure drop requirement and still have enough surface area exposure to have sufficient heat transfer in the exchanger. Regenerators are considered regenerative heat exchangers where a working fluid such as gas flows through the heat exchanger in alternating directions to deposit heat or gain heat.

The Vuilleumier heat pump, a highly efficient thermodynamic system, relies heavily on the performance of its regenerators. These regenerators play a key role in the thermodynamic cycle by acting as “thermal capacitors” to store and deliver heat to the working fluid traveling through them. For instance, hot and cold chambers of a Vuilleumier heat pump are able to maintain a temperature differential to drive a Vuilleumier cycle and a regenerator stores excess or unused thermal energy as the working fluid moves back and forth between the chambers. In playing such a critical role in the cycle, the design and fabrication of the regenerator must be very intentional to ensure optimal performance. Current regenerator designs face significant challenges that impede their efficiency and effectiveness. Among these challenges are non-uniform matrix structures, bypass issues, and thermal insulation issues.

Non-uniform matrix structures often due to imperfections in a regenerator matrix can lead to non-uniform flow distribution. This inconsistency in flow can cause significant drops in performance, as it results in inefficient heat transfer and uneven temperature gradients.

Another critical problem is leakage between a regenerator's matrix and its liner. This leakage undermines the regenerator's ability to maintain pressure and temperature differentials. This results in a direct bypass between chambers and further reduces the overall efficiency of the heat pump.

Improvement to thermal insulation within regenerators is also needed. The absence of adequate insulation layers between a regenerator and a hot or cold working gas chamber of a heat engine or pump results in thermal losses and decreased performance.

The embodiments of the present disclosure provide solutions to the aforementioned problems associated with existing regenerators in the form of a hot regenerator and a cold regenerator that each store and deliver thermal energy to a working fluid and maintain a temperature difference between at least one hot chamber (e.g., approximately 500 degrees Celsius (° C.)) and at least one cold chamber (e.g., approximately at or below 0° C.). The regenerators described herein can each be embodied and implemented as a radially insulated regenerator having at least one of an insulation layer or a porous layer positioned between an inner liner and a bulk matrix material of the regenerator. Some embodiments omit the insulation layer, other embodiments omit the porous layer, and still other embodiments include both the insulation layer and the porous layer positioned between an inner liner and a bulk matrix material of the regenerator.

The insulation layer can be positioned between the inner liner and the porous layer in some cases, and the porous layer can be positioned between the insulation layer and an inner side of the bulk matrix material in these examples. The insulation layer can include or be embodied in some cases as a mica material such as one or more mica sheets, a ceramic insulation material, a fiber blanket material, a thermal sprayed insulation composite material, another insulation material, or any combination thereof. The porous layer can include or be embodied as a material having a relatively lower porosity (e.g., 40% porosity) compared to a porosity (e.g., 70% porosity) of the bulk matrix material. The relatively low porosity of the porous layer can reduce flow and heat transfer near the regenerator's inner liner. For instance, the relatively low porosity of the porous layer can reduce fluid flow and heat transfer at or near one or more interfaces between the inner side of the bulk matrix material and the porous layer, the porous layer and the insulation layer, or the insulation layer and the inner liner of the regenerator.

Some embodiments can include a second porous layer positioned between an outer liner of the regenerator and an outer surface of the regenerator's matrix. The second porous layer can also include or be embodied as a material having a relatively lower porosity compared to that of the bulk matrix material. The material or porosity used to form each of the porous layers can be the same in some examples or different in others. The relatively low porosity of the second porous layer can reduce flow and heat transfer near the regenerator's outer liner. For instance, the relatively low porosity of the second porous layer can reduce fluid flow and heat transfer at or near one or more interfaces between the outer side of the bulk matrix material and the second porous layer or the second porous layer and the outer liner of the regenerator.

Other embodiments can include at least one diffuser positioned at one or more ends of the regenerator between the inner liner and the outer liner of the regenerator. The diffusers can each be embodied as a perforated plate having an annular geometry in some cases. The perforated plate can include apertures formed and extending through a thickness of the perforated plate from an inner surface to an outer surface of the perforated plate. The apertures can be formed through the perforated plate in a defined pattern in some cases. The diffusers can be positioned and oriented at different ends of the regenerator in some examples such that their respective apertures are aligned with one another along a length of the regenerator. For instance, the diffusers can be positioned and oriented at different ends of the regenerator such that apertures formed in a perforated plate of one diffuser positioned at one end of a regenerator can be aligned lengthwise with corresponding apertures formed in a perforated plate of another diffuser positioned at another end of the regenerator. Each of the diffusers in many cases provides structural support for the regenerator (e.g., for the bulk matrix material) and creates a relatively even fluid flow for a working fluid moving into, through, and out of the regenerator. Such even distribution of a working fluid by each diffuser ensures a more uniform and improved heat transfer through the regenerator, as there are limited or even no areas in the working fluid that have more or less flow than other areas.

Still other embodiments can include secondary heat exchangers for use in conjunction with the regenerator to perform thermodynamic cycles in a heat pump or heat engine system. Example secondary heat exchangers each include an outer shell having a geometry at least partly defining a mixing chamber (or “diffusion chamber”) at a respective end of the regenerator. The outer shells of the secondary heat exchangers can be designed and embodied with the same geometry to define mixing chambers having the same shape in some cases. In other examples, the outer shells of the secondary heat exchangers can be designed and embodied with different geometries to define mixing chambers having different shapes. The mixing chambers create a relatively even fluid flow for a working fluid moving into, through, and out of the regenerator. Even distribution of a working fluid created by at least one of the diffusers or the mixing chambers ensures a more uniform and improved heat transfer through the regenerator, as there are limited or even no areas in the working fluid that have more or less flow than other areas.

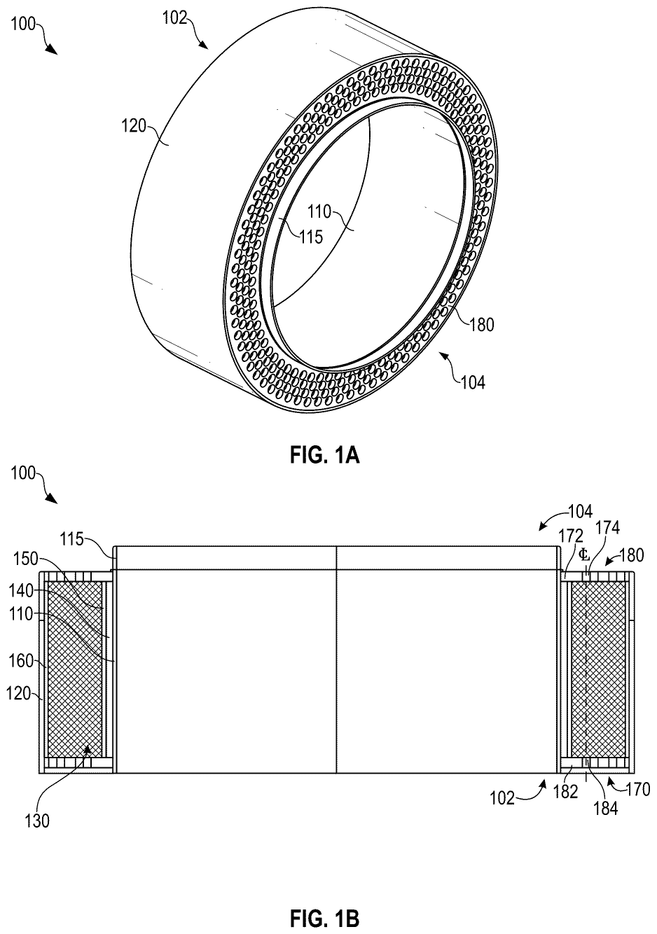

For initial context, FIG. 1A illustrates a perspective view of an example regenerator device 100 (or “regenerator 100”) in accordance with various aspects and embodiments of the present disclosure. FIG. 1B illustrates a cross-sectional side view of the regenerator 100 shown in FIG. 1A in accordance with various aspects and embodiments of the present disclosure.

The regenerator 100 is illustrated as a representative example of a radially insulated regenerator having at least one of an insulation layer or a porous layer positioned between an inner liner and a bulk matrix material of the regenerator. The regenerator 100 can be designed, embodied, and implemented as a hot regenerator in some examples and as a cold regenerator in others. The regenerator 100 can store and deliver thermal energy to a working fluid and maintain a temperature difference between at least one hot chamber (e.g., approximately 500 degrees ° C.) and at least one cold chamber (e.g., approximately at or below 0° C.). The regenerator 100 can be implemented in conjunction with one or more secondary heat exchangers in a heat pump or heat engine system in some cases to perform thermodynamic cycles such as Stirling and Vuilleumier thermodynamic cycles. The concepts described herein can be extended to use with a range of regenerators, heat exchangers, and heat pump or engine systems of different types, styles, components, and configurations, however.

The regenerator 100 is not drawn to any particular scale or size in the drawings. The shape, size, proportion, and other characteristics of the regenerator 100 and the components thereof can vary as compared to that shown. Additionally, one or more of the parts or components of the regenerator 100, as illustrated in the drawings and described herein, can be omitted in some cases. The regenerator 100 can also include other parts or components that are not illustrated.

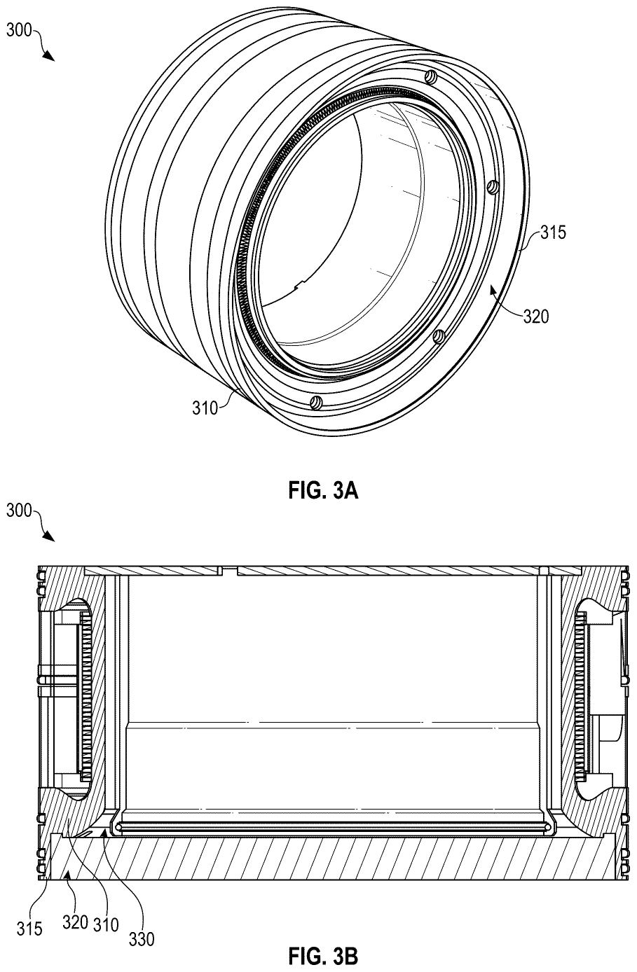

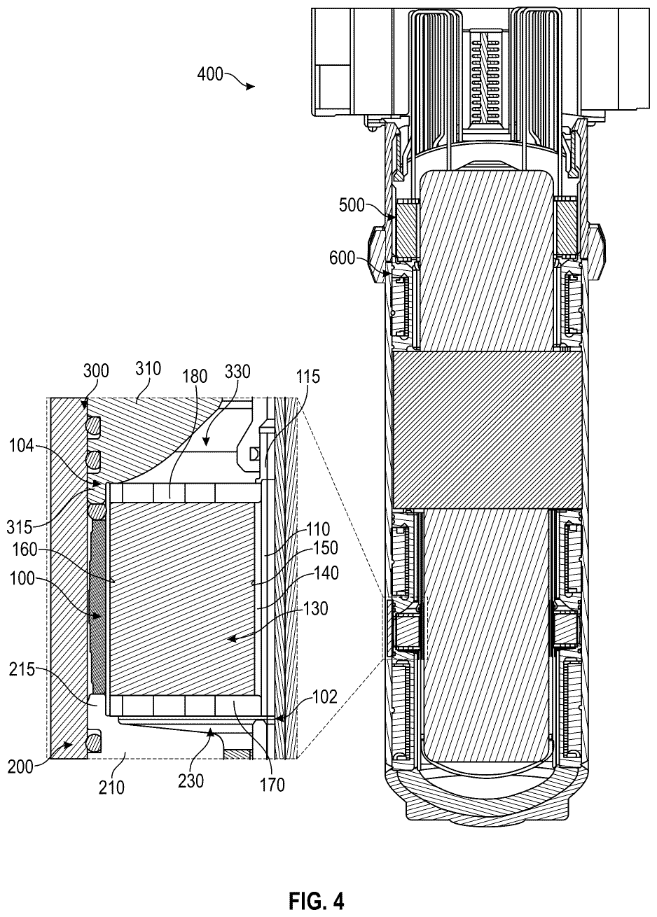

Among other components, the regenerator 100 shown in FIGS. 1A and 1B includes an inner liner 110, an outer liner 120, and a bulk matrix material 130 positioned between the inner liner 110 and the outer liner 120 in this example. The regenerator 100 further includes an insulation layer 140 and an inner porous layer 150 positioned between the inner liner 110 and the bulk matrix material 130, and an outer porous layer 160 positioned between the outer liner 120 and the bulk matrix material 130 in the example shown. The regenerator 100 also includes a seal carrier 115 coupled to and extending from an end of the inner liner 110. The seal carrier 115 allows for coupling and sealing of the regenerator 100 to a secondary heat exchanger in a heat pump or heat engine system such as the secondary heat exchanger 300 in the heat pump system 400 described herein and illustrated in FIGS. 3A, 3B, and 4.

The inner liner 110 and the outer liner 120 can be embodied as or include the same material in some cases or different material in other cases. The inner liner 110 and the outer liner 120 can each be embodied as or include material such as steel, stainless steel, copper, aluminum, graphene, any combination thereof, and so forth in some examples, although in other examples another material may be used to form either or both of the inner liner 110 or the outer liner 120. The inner liner 110 and the outer liner 120 can each be embodied as or include stainless steel such as 303, 304, 316, 409, or 420 stainless steel, or another grade of stainless steel in various examples.

The bulk matrix material 130 can be embodied as or include any type of bulk material. For instance, the bulk matrix material 130 can be embodied as or include wire screen bulk or mesh material, sintered beads, knitted wire, another type of bulk material, or any combination thereof. The bulk matrix material 130 can be embodied as or include one layer or multiple layers of bulk material in some cases. The bulk matrix material 130 and any individual layer thereof can be designed and embodied to a desired porosity. The bulk matrix material 130 in many examples can be embodied as or include at least one of wire screen or one or more wire screen layers. For instance, the bulk matrix material 130 can be embodied as or include a wire screen bulk or mesh material having a desired porosity in some cases. In another example, the bulk matrix material 130 can be embodied as or include discrete wire screen layers stacked on one another between the inner liner 110 and the outer liner 120 to collectively provide the desired porosity. For instance, each of the wire screen layers can be embodied as or include a wire screen bulk or mesh material having a desired porosity in some cases. In another example, one or more of the wire screen layers can be embodied as or include a wire screen bulk or mesh material having a porosity that is different from that of at least one other wire screen layer in the bulk matrix material 130.

The insulation layer 140 can be embodied as or include any type of insulation layer. For instance, the insulation layer 140 can be embodied as or include a mica material, a ceramic insulation material, a fiber blanket material, a thermal sprayed insulation composite material, another insulation material, or any combination thereof. In one example, the insulation layer 140 can be embodied as or include one or more mica sheets. The insulation layer 140 can be created or applied by way of a high temperature adhesive or a thermal spray in some cases.

The inner porous layer 150 can be embodied as or include a bulk material in various examples. For instance, the inner porous layer 150 can be embodied as or include wire screen bulk or mesh material, sintered beads, knitted wire, another type of bulk material, or any combination thereof. The inner porous layer 150 can be embodied as or include a layer of bulk material in some examples. The inner porous layer 150 can be designed and embodied to a desired porosity. For instance, the inner porous layer 150 can be embodied as or include a wire screen or mesh material layer having a defined porosity that is less than that of the bulk matrix material 130 in many cases. For instance, the inner porous layer 150 can include or be embodied as a material having a relatively lower porosity such as approximately 5%-55% porosity compared to a porosity of approximately 60%-95% porosity of the bulk matrix material 130 in some cases, although other porosities may be relied upon in other examples. In one example, the inner porous layer 150 can include or be embodied as a material having approximately 40% porosity and the bulk matrix material 130 can be embodied as or include a material having approximately 70% porosity. The relatively low porosity of the inner porous layer 150 can reduce flow and heat transfer near the inner liner 110 of the regenerator 100. For instance, the relatively low porosity of the inner porous layer 150 can reduce fluid flow and heat transfer at or near one or more interfaces between the inner side of the bulk matrix material 130 and the inner porous layer 150, the inner porous layer 150 and the insulation layer 140, or the insulation layer 140 and the inner liner 110 of the regenerator 100.

The outer porous layer 160 can also be embodied as or include a bulk material in various examples. For instance, the outer porous layer 160 can be embodied as or include wire screen bulk or mesh material, sintered beads, knitted wire, another type of bulk material, or any combination thereof. The outer porous layer 160 can be embodied as or include a layer of bulk material in some examples. The outer porous layer 160 can be designed and embodied to a desired porosity. For instance, the outer porous layer 160 can be embodied as or include a wire screen or mesh material layer having a defined porosity that is less than that of the bulk matrix material 130. The material used to form each of the inner and outer porous layers 150, 160 can be the same in some examples or different in others. The porosity of each of the inner and outer porous layers 150, 160 can be the same in some examples or different in others. For instance, the outer porous layer 160 can include or be embodied as a material having approximately 5%-55% porosity in some cases, although other porosities may be relied upon in other examples. In one example, the outer porous layer 160 can include or be embodied as a material having approximately 40% porosity. The relatively low porosity of the outer porous layer 160 can reduce flow and heat transfer near the outer liner 120 of the regenerator 100. For instance, the relatively low porosity of the outer porous layer 160 can reduce fluid flow and heat transfer at or near one or more interfaces between the outer side of the bulk matrix material 130 and the outer porous layer 160 or the outer porous layer 160 and the outer liner 120 of the regenerator 100.

The insulation layer 140 is positioned between the inner liner 110 and the inner porous layer 150 in the example shown. The inner porous layer 150 is positioned between the insulation layer 140 and an inner side of the bulk matrix material 130 in this example, and the outer porous layer 160 is positioned between the outer liner 120 and an outer side of the bulk matrix material 130. The arrangement of one or more of the bulk matrix material 130, the insulation layer 140, the inner porous layer 150, or the outer porous layer 160 relative to one another may be different from what is shown in FIG. 1B in another example.

In some cases, one or more of the insulation layer 140, the inner porous layer 150, or the outer porous layer 160 may be omitted from the regenerator 100. For instance, some embodiments of the regenerator 100 include the insulation layer 140 and omit both the inner and outer porous layers 150, 160. Other embodiments of the regenerator 100 include the insulation layer 140 and one or both of the inner or outer porous layers 150, 160. Still other embodiments of the regenerator 100 include one or both of the inner or outer porous layers 150, 160 and omit the insulation layer 140. Yet still other embodiments of the regenerator 100 include the insulation layer 140 and both of the porous layers 150, 160 as illustrated in FIGS. 1A and 1B.

The regenerator 100 also includes one or more diffusers 170, 180 positioned at one or more ends 102, 104 of the regenerator 100 between the inner liner 110 and the outer liner 120 of the regenerator 100. The diffuser 170 is positioned at the end 102 of the regenerator 100 and the diffuser 180 is positioned at the end 104 of the regenerator 100 in the example shown. The diffusers 170, 180 in this example are embodied as perforated plates 172, 182, respectively. The perforated plates 172, 182 in the example shown have an annular shape and include apertures 174, 184, respectively. Only a single aperture 174 and a single aperture 184 are denoted in FIG. 1B for illustrative clarity. The apertures 174, 184 are formed in a defined pattern through an entire thickness of their corresponding perforated plate 172, 182, from an inner surface to an outer surface of the plate.

The perforated plates 172, 182 include corresponding apertures 174, 184 formed through the plates in this example. For instance, each of the apertures 174 is aligned with a corresponding aperture 184 along a common centerline axis “℄” shared by the apertures. To achieve this alignment, the perforated plates 172, 182 are positioned and oriented at respective ends 102, 104 of the regenerator 100 in the example shown such that their respective apertures 174, 184 are aligned with one another along such a common centerline axis ℄ for a length of the regenerator 100. For instance, the apertures 174 formed in the perforated plate 172 of the diffuser 170 positioned at the end 102 of the regenerator 100 are aligned lengthwise with corresponding apertures 184 formed in the perforated plate 182 of the diffuser 180 positioned at the end 104 of the regenerator 100.

Each of the diffusers 170, 180 provides at least partial structural support for the regenerator 100 (e.g., for the bulk matrix material 130). Each of the diffusers 170, 180 also creates a relatively even fluid flow for a working fluid moving into, through, and out of the regenerator 100 during its operation. Such even distribution of a working fluid by each of the diffusers 170, 180 ensures a more uniform and improved heat transfer through the regenerator 100, as there are limited or even no areas in the working fluid that have more or less flow than other areas during operation of the regenerator 100. The apertures 174, 184 and the alignment of the apertures 174, 184 creates a relatively even fluid flow for a working fluid moving into, through, and out of the regenerator 100 during its operation in many cases. Example working fluids described herein include, but are not limited to, helium, hydrogen, or another working fluids.

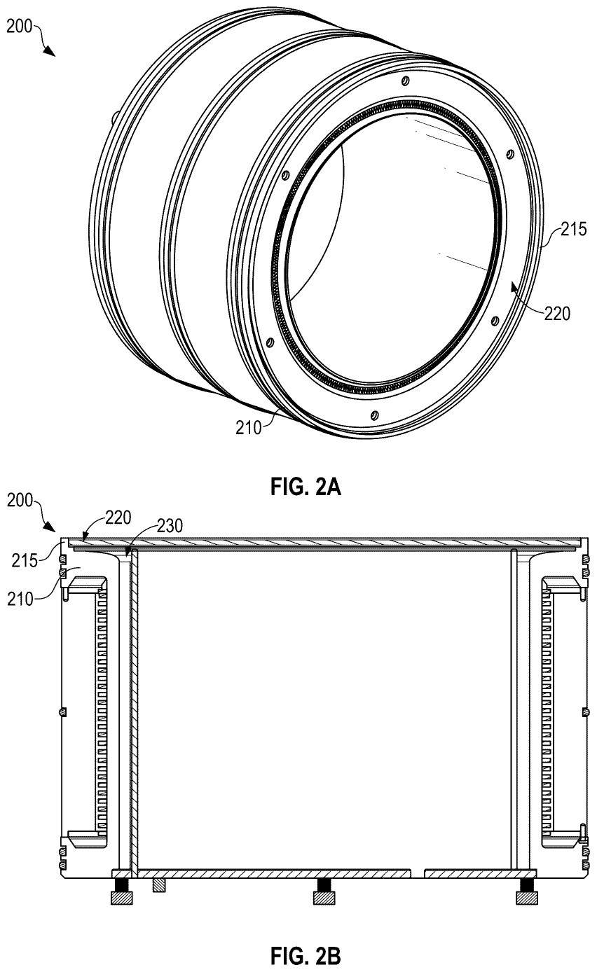

FIG. 2A illustrates a perspective view of an example secondary heat exchanger device 200 (or “secondary heat exchanger 200”) in accordance with various aspects and embodiments of the present disclosure. FIG. 2B illustrates a cross-sectional side view of the secondary heat exchanger device 200 shown in FIG. 2A in accordance with various aspects and embodiments of the present disclosure.

The secondary heat exchanger 200 is illustrated as a representative example of a secondary heat exchanger having a mixing chamber or diffusion chamber that partly creates a relatively even fluid flow for a working fluid moving into, through, and out of a radially insulated regenerator coupled to the secondary heat exchanger 200. The secondary heat exchanger 200 is also illustrated as a representative example of a secondary heat exchanger that can be used in conjunction with a radially insulated regenerator having at least one of an insulation layer or a porous layer positioned between an inner liner and a bulk matrix material of the regenerator. The concepts described herein can be extended to use with a range of regenerators, heat exchangers, and heat pump or engine systems of different types, styles, components, and configurations, however.

The secondary heat exchanger 200 can be designed, embodied, and implemented in conjunction with the regenerator 100 described herein with reference to FIGS. 1A and 1B to perform thermodynamic cycles in a heat pump or heat engine system in some examples. For instance, the secondary heat exchanger 200 can be coupled to the regenerator 100 in the heat pump system 400 described herein with reference to FIG. 4 to perform Stirling and Vuilleumier thermodynamic cycles in some cases.

The secondary heat exchanger 200 is not drawn to any particular scale or size in the drawings. The shape, size, proportion, and other characteristics of the secondary heat exchanger 200 and the components thereof can vary as compared to that shown. Additionally, one or more of the parts or components of the secondary heat exchanger 200, as illustrated in the drawings and described herein, can be omitted in some cases. The secondary heat exchanger 200 can also include other parts or components that are not illustrated.

Among other components, the secondary heat exchanger 200 shown in FIGS. 2A and 2B includes an outer shell 210 having a seal receiver 215 that at least partly defines a port 220 in the outer shell 210 in this example. The outer shell 210 can be embodied as or include an aluminum material in many cases. For instance, the outer shell 210 can be embodied as or include aluminum 6160 in some examples. The outer shell 210, the seal receiver 215, and the port 220 are designed and embodied to receive and at least partly support an end of a radially insulated regenerator such as the end 102 of the regenerator 100 in some cases. The outer shell 210 in the example shown has a geometry that at least partly defines a mixing chamber 230 (or “diffusion chamber 230”) in the outer shell 210. The geometry of the outer shell 210 in this example partly defines the mixing chamber 230 such that the chamber is located at and against the end 102 of the regenerator 100 when the regenerator 100 is coupled to the secondary heat exchanger 200. An example dynamic coupling of the regenerator 100 to the outer shell 210 of the secondary heat exchanger 200 is illustrated in FIG. 4 and described herein with reference to the heat pump system 400.

The mixing chamber 230 creates a relatively even fluid flow for a working fluid moving into, through, and out of the regenerator 100 when the regenerator 100 is coupled to the secondary heat exchanger 200 (e.g., as shown in FIG. 4). Even distribution of a working fluid created by at least one of the diffusers 170, 180 or the mixing chamber 230 when the regenerator 100 is coupled to the secondary heat exchanger 200 ensures a more uniform and improved heat transfer through the regenerator 100, as there are limited or even no areas in the working fluid that have more or less flow than other areas.

FIG. 3A illustrates a perspective view of another example secondary heat exchanger device 300 (or “secondary heat exchanger 300”) in accordance with various aspects and embodiments of the present disclosure. FIG. 3B illustrates a cross-sectional side view of the secondary heat exchanger device 300 shown in FIG. 3A in accordance with various aspects and embodiments of the present disclosure.

The secondary heat exchanger 300 is illustrated as another representative example of a secondary heat exchanger having a mixing chamber or diffusion chamber that partly creates a relatively even fluid flow for a working fluid moving into, through, and out of a radially insulated regenerator coupled to the secondary heat exchanger 300. The secondary heat exchanger 300 is also illustrated as a representative example of a secondary heat exchanger that can be used in conjunction with a radially insulated regenerator having at least one of an insulation layer or a porous layer positioned between an inner liner and a bulk matrix material of the regenerator. The concepts described herein can be extended to use with a range of regenerators, heat exchangers, and heat pump or engine systems of different types, styles, components, and configurations, however.

The secondary heat exchanger 300 can be designed, embodied, and implemented in conjunction with the regenerator 100 described herein with reference to FIGS. 1A and 1B to perform thermodynamic cycles in a heat pump or heat engine system in some examples. For instance, the secondary heat exchanger 300 can be coupled to the regenerator 100 in the heat pump system 400 described herein with reference to FIG. 4 to perform Stirling and Vuilleumier thermodynamic cycles in some cases.

The secondary heat exchanger 300 is not drawn to any particular scale or size in the drawings. The shape, size, proportion, and other characteristics of the secondary heat exchanger 300 and the components thereof can vary as compared to that shown. Additionally, one or more of the parts or components of the secondary heat exchanger 300, as illustrated in the drawings and described herein, can be omitted in some cases. The secondary heat exchanger 300 can also include other parts or components that are not illustrated.

Among other components, the secondary heat exchanger 300 shown in FIGS. 3A and 3B includes an outer shell 310 having a seal receiver 315 that at least partly defines a port 320 in the outer shell 310. The outer shell 310 can be embodied as or include an aluminum material in many cases. For instance, the outer shell 310 can be embodied as or include aluminum 6160 in some examples. The outer shell 310, the seal receiver 315, and the port 320 are designed and embodied to receive and at least partly support a seal carrier at an end of a radially insulated regenerator such as the seal carrier 115 of the regenerator 100 in some cases. The outer shell 310 in the example shown has a geometry that at least partly defines a mixing chamber 330 (or “diffusion chamber 330”) in the outer shell 310. The geometry of the outer shell 310 in this example partly defines the mixing chamber 330 such that the chamber is located at and against the end 104 of the regenerator 100 when the regenerator 100 is coupled to the secondary heat exchanger 300. An example dynamic coupling of the regenerator 100 to the outer shell 310 of the secondary heat exchanger 300 is illustrated in FIG. 4 and described herein with reference to the heat pump system 400.

The mixing chamber 330 creates a relatively even fluid flow for a working fluid moving into, through, and out of the regenerator 100 when the regenerator 100 is coupled to the secondary heat exchanger 300 (e.g., as shown in FIG. 4). Even distribution of a working fluid created by at least one of the diffusers 170, 180 or the mixing chamber 330 when the regenerator 100 is coupled to the secondary heat exchanger 300 ensures a more uniform and improved heat transfer through the regenerator 100, as there are limited or even no areas in the working fluid that have more or less flow than other areas.

FIG. 4 illustrates a cross-sectional side view of an example heat pump system 400 in accordance with various aspects and embodiments of the present disclosure. In particular, the inset shown in FIG. 4 illustrates a cross-sectional side view of an example dynamic coupling of the regenerator 100 to the secondary heat exchangers 200, 300 in accordance with various aspects and embodiments of the present disclosure.

The heat pump system 400 is illustrated as a representative example of a heat pump or heat engine system that can include a radially insulated regenerator having at least one of an insulation layer or a porous layer positioned between an inner liner and a bulk matrix material of the regenerator. The heat pump system 400 is also illustrated as a representative example of a heat pump or heat engine system that can include a radially insulated regenerator and a secondary heat exchanger having a mixing chamber or diffusion chamber that partly creates a relatively even fluid flow for a working fluid moving into, through, and out of the regenerator. The concepts described herein can be extended to use with a range of regenerators, heat exchangers, and heat pump or engine systems of different types, styles, components, and configurations, however.

The heat pump system 400 can include the regenerator 100 and the secondary heat exchangers 200, 300 in some examples. The heat pump system 400, the regenerator 100, and the secondary heat exchangers 200, 300 can be designed, embodied, and implemented in conjunction with one another in some cases to perform thermodynamic cycles within the heat pump system 400. For instance, each of the secondary heat exchangers 200, 300 can be coupled to the regenerator 100 in the heat pump system 400 to perform Stirling and Vuilleumier thermodynamic cycles in some cases.

The heat pump system 400 is not drawn to any particular scale or size in the drawings. The shape, size, proportion, and other characteristics of the heat pump system 400 and the components thereof can vary as compared to that shown. Additionally, one or more of the parts or components of the heat pump system 400, as illustrated in the drawings and described herein, can be omitted in some cases. The heat pump system 400 can also include other parts or components that are not illustrated.

Among other components, the heat pump system 400 shown in FIG. 4 includes the secondary heat exchangers 200, 300 coupled to the ends 102, 104, respectively, of the regenerator 100. As shown in the inset depicted in FIG. 4, the geometry of the outer shell 210 in this example at least partly defines the mixing chamber 230 at the end 102 of the regenerator 100 when the regenerator 100 is coupled to the secondary heat exchanger 200. Also, the geometry of the outer shell 310 in this example at least partly defines the mixing chamber 330 at the end 104 of the regenerator 100 when the regenerator 100 is coupled to the secondary heat exchanger 300.

The diffusers 170, 180 and the mixing chambers 230, 330 create a relatively even fluid flow for a working fluid moving into, through, and out of the regenerator 100 when the regenerator 100 is coupled to the secondary heat exchangers 200, 300 as shown in FIG. 4. Even distribution of a working fluid created by such components ensures a more uniform and improved heat transfer through the regenerator 100, as there are limited or even no areas in the working fluid that have more or less flow than other areas.

The heat pump system 400 further includes another regenerator device 500 (or “regenerator 500”) coupled to another secondary heat exchanger 600. In the example shown, the regenerators 100, 500 can be embodied and implemented as a cold regenerator and a hot regenerator, respectively. The regenerator 500 in this example includes the same or similar components, attributes, and functional ability as that of the regenerator 100 described herein with reference to FIGS. 1A and 1B, and the secondary heat exchanger 600 includes the same or similar components, attributes, and functional ability as that of the secondary heat exchanger 200 described herein with reference to FIGS. 2A and 2B. For instance, the secondary heat exchanger 600 includes an outer shell (e.g., aluminum 6160) having a geometry that at least partly defines a mixing chamber at an end of the regenerator 500 that creates an even distribution of a working fluid moving into, through, and out of the regenerator 500 when it is coupled to the secondary heat exchanger 600 as shown in FIG. 4.

The features, structures, or characteristics described above may be combined in one or more embodiments in any suitable manner, and the features discussed in the various embodiments are interchangeable, if possible. In the above description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account for at least some manufacturing tolerances between a theoretical design and manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. Further, if a component is described as there being “at least one” of said component, it is understood that this may mean “one or more” of said component. Conversely, if a component is described as there being “one or more” of said component, it is understood that this may mean “at least one” of said component.

As referenced herein in the context of quantity, the terms “a” or “an” are intended to mean “at least one” and are not intended to imply “one and only one.” As referred to herein, the terms “include,” “includes,” and “including” are each intended to be inclusive in a manner similar to the term “comprising.” As referenced herein, the terms “or” and “and/or” are generally intended to be inclusive, that is (i.e.), “A or B” or “A and/or B” are each intended to mean “A or B or both.” As referred to herein, the terms “first,” “second,” “third,” and so on, can be used interchangeably to distinguish one component or entity from another and are not intended to signify location, functionality, or importance of the individual components or entities. As referenced herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling), mechanical coupling, operative coupling, optical coupling, fluid coupling, thermal coupling, and/or physical coupling.

It should be emphasized that the above-described embodiments of the present disclosure are merely possible examples of implementations set forth for a clear understanding of the principles of the disclosure. Many variations and modifications can be made to the above-described embodiment(s) without departing substantially from the spirit and principles of the disclosure. All such modifications and variations are intended to be included herein within the scope of this disclosure and protected by the following claims.

Therefore, at least the following is claimed:

1. A regenerator device, comprising:
an inner liner;
an outer liner;
a bulk matrix material positioned between the inner liner and the outer liner;
an insulation layer positioned between the inner liner and the bulk matrix material; and
a porous layer positioned between the inner liner and the bulk matrix material.

2. The regenerator device of claim 1, wherein the insulation layer is positioned between the inner liner and the porous layer.

3. The regenerator device of claim 1, wherein the porous layer is positioned between the insulation layer and an inner side of the bulk matrix material.

4. The regenerator device of claim 1, wherein the bulk matrix material comprises at least one of a bulk material, one or more bulk material layers, a wire screen bulk or mesh material, sintered beads, or knitted wire.

5. The regenerator device of claim 1, wherein the insulation layer comprises at least one of a mica material, a ceramic insulation material, a fiber blanket material, a thermal sprayed insulation composite material, or one or more mica sheets.

6. The regenerator device of claim 1, wherein the porous layer has a porosity that is lower than a porosity of the bulk matrix material.

7. The regenerator device of claim 1, wherein the porous layer comprises at least one of wire screen, one or more wire screen layers, wire screen bulk or mesh material, sintered beads, or knitted wire.

8. The regenerator device of claim 1, further comprising:
a second porous layer positioned between the outer liner of the regenerator and an outer side of the bulk matrix material.

9. The regenerator device of claim 8, wherein the second porous layer has a porosity that is lower than a porosity of the bulk matrix material.

10. The regenerator device of claim 1, further comprising:
at least one diffuser positioned at one or more ends of the regenerator device between the inner liner and the outer liner of the regenerator.

11. The regenerator device of claim 10, wherein the at least one diffuser comprises a perforated plate having apertures formed in a defined pattern through a thickness of the perforated plate from an inner surface to an outer surface of the perforated plate.

12. The regenerator device of claim 10, wherein:
the at least one diffuser comprises two perforated plates positioned at respective ends of the regenerator device between the inner liner and the outer liner of the regenerator;
the two perforated plates comprise corresponding apertures formed through the two perforated plates; and
the corresponding apertures are aligned with one another along a length of the regenerator device.

13. A regenerator device, comprising:
an inner liner;
an outer liner;
a bulk matrix material positioned between the inner liner and the outer liner;
an inner porous layer positioned between the inner liner and the bulk matrix material; and
an outer porous layer positioned between the outer liner and the bulk matrix material.

14. The regenerator device of claim 13, wherein the bulk matrix material comprises at least one of a bulk material, one or more bulk material layers, a wire screen bulk or mesh material, sintered beads, or knitted wire.

15. The regenerator device of claim 13, wherein at least one of the inner porous layer or the outer porous layer has a porosity that is lower than a porosity of the bulk matrix material.

16. The regenerator device of claim 13, wherein the inner porous layer and the outer porous layer each have a same porosity or a different porosity relative to one another.

17. The regenerator device of claim 13, wherein at least one of the inner porous layer or the outer porous layer comprises at least one of wire screen, one or more wire screen layers, wire screen bulk or mesh material, sintered beads, or knitted wire.

18. A heat pump system, comprising:
a first secondary heat exchanger;
a second secondary heat exchanger; and
a regenerator device coupled to the first secondary heat exchanger and the second secondary heat exchanger, the regenerator device comprising:
an inner liner;
an outer liner;
a bulk matrix material positioned between the inner liner and the outer liner;
an insulation layer positioned between the inner liner and the bulk matrix material; and
a porous layer positioned between the inner liner and the bulk matrix material.

19. The heat pump system of claim 18, wherein:
the first secondary heat exchanger comprises a first outer shell having a first geometry at least partly defining a first mixing chamber at a first end of the regenerator device; and
the second secondary heat exchanger comprises a second outer shell having a second geometry at least partly defining a second mixing chamber at a second end of the regenerator device.

20. The heat pump system of claim 18, further comprising:
a second regenerator device coupled to a third secondary heat exchanger,
wherein the third secondary heat exchanger comprises an outer shell having a geometry at least partly defining a mixing chamber at an end of the regenerator device.
